(19) United States
(12) Patent Application Publication
(10) Pub. No.: US 2011/0161281 A1
(43) Pub. Date: Jun. 30, 2011

(54) Distributed Transaction Management in a Distributed Shared Disk Cluster Environment

(75) Inventors: Sunil Sayyaparaju, Vedureswaram (IN); Amit Anantrao Pathak, Nanded (IN)

(73) Assignee: Sybase, Inc., Dublin, CA (US)

(21) Appl. No.: 12/650,451

(22) Filed: Dec. 30, 2009

(51) Int. Cl. G06F 17/00; G06F 12/00

(52) U.S. Cl. 707/607; 711/112; 707/E17.005; 711/E12.001

(57) ABSTRACT

Systems, methods, computer program product embodiments are provided for maintaining transaction consistency for distributed transactions in a distributed shared disk cluster environment. An embodiment includes utilizing broadcast messaging among the plurality of instances to identify at least one of a transaction and a transaction owner instance for a transaction request. Execution of the transaction occurs on an owner instance as found based on a response to the broadcast messaging.

### BACKGROUND

1. Field of the Invention

The present invention relates generally to data processing environments, and more particularly to in a distributed shared disk cluster data processing environment.

2. Background Art

Computers are very powerful tools for storing and providing access to vast amounts of information. Computer databases are a common mechanism for storing information on computer systems while providing easy access to users. A typical database is an organized collection of related information stored as “records” having “fields” of information. As an example, a database of employees may have a record for each employee where each record contains fields designating specifics about the employee, such as name, home address, salary, and the like.

Between the actual physical database itself (i.e., the data actually stored on a storage device) and the users of the system, a database management system or DBMS is typically provided as a software cushion or layer. In essence, the DBMS shields the database user from knowing or even caring about the underlying hardware-level details. Typically, all requests from users for access to the data are processed by the DBMS. For example, information may be added or removed from data files, information retrieved from or updated in such files, and so forth, all without user knowledge of the underlying system implementation. In this manner, the DBMS provides users with a conceptual view of the database that is removed from the hardware level. The general construction and operation of database management systems is well known in the art. See e.g., Date, C., “An Introduction to Database Systems, Seventh Edition”, Part I (especially Chapters 1-4), Addison Wesley, 2000.

Distributed transaction management (DTM) is an essential component of any database server. It allows a database server to be a part of distributed transaction. A distributed transaction spans across multiple database servers and is coordinated by a central entity. Database servers involved in the transaction are generally referred to as Resource Managers (RMs). RMs contribute their resources for the transaction and can manage those resources. An agent which coordinates the state of the transactions on different servers is called as Transaction Manager (TM). TM assures that the transaction commits (or aborts), it commits (or aborts) on all the RMs.

Support for distributed transaction management has been successfully achieved for symmetric multiprocessor (SMP) database systems in such products as the ASE product from Sybase Inc. of Dublin, Calif., that provide fast performance by making multiple CPUs available to complete individual processes simultaneously (multiprocessing). Distributed transaction protocols are known for such systems and are used by the TM to instruct the RM to perform various operations (like begin, prepare, commit, rollback, etc) on the transaction running on that instance. For example, X/Open-XA is the distributed transaction protocol proposed by the X/Open organization which is supported by many database vendors, MSDTC is a proprietary protocol of Microsoft Corporation of Redmond, Wash. to support distributed transactions, and ASTC is Sybase's proprietary mechanism to support DTM for ASE, which allows an ASE installation to act as TM and coordinate other ASE installations. Some of the DTM protocols like XOpen/XA allow the TM to close the connection to the RM once it detaches from the transaction branch, and the TM can resume the work on the transaction branch by using a different connection. Distributed transactions usually follow two phase commit (2PC) mechanism where these phases are driven by the TM.

An example usage scenario of DTM execution is shown FIG. 1. As shown, the TM 102 issues a begin command to an RM 104 to begin a branch of the distributed transaction on the RM 104. Once a transaction branch has started, TM 102 attaches to the transaction by issuing attach command and then runs the SQL statements within the transaction. After some time, TM 102 can detach from the transaction by issuing detach command. The attach-SQL-detach block can be repeated many times.

Finally, when all the SQLs are finished, TM 102 issues prepare command to each RM 104 involved in the transaction. By issuing prepare, TM 102 informs an RM 104 that all the DMLs in the transactions are finished and asks each RM 104 to prepare the transaction branch so that it can commit or abort the branch without failing as directed by TM 102. Each RM 104 then prepares its transaction branch so that under any circumstances it can follow the upcoming commit/abort command. Preparing the transaction can involve flushing the transaction logs to disk, etc., so as to ensure that the RM 104 will be able to commit/abort the transaction even in case of failures. If an RM 104 can prepare the transaction branch, it returns SUCCESS message to TM 102.

Before replying SUCCESS to the prepare command, an RM 104 can unilaterally abort the transaction branch at any moment, but once it replies SUCCESS to prepare command, it is bound to follow the upcoming commit/abort command from the TM 102. SUCCESS message for prepare command can be thought of as promise from RM 104 to TM 102 that henceforth it will follow the commit/abort command from the TM 102 and will not unilaterally commit/abort the transaction.

After issuing the prepare command to all the RMs 104, TM 102 waits for a reply from each of the RMs 104. If one of the RMs 104 does not reply with SUCCESS message, the TM 102 decides to abort the transaction and informs all the RMs 104 to abort their transaction branches. TM 102 can commit the transaction only if all the RMs 104 reply with SUCCESS message.

When all the RMs 104 return with SUCCESS message, the first phase of the 2PC protocol is said to be finished. When all the RMs 104 commit/abort their transaction branches following subsequent commit/abort command from TM 102, the second phase of 2PC protocol is said to be finished.

Distributed transaction support is also desired in SDC (Shared Disk Cluster) systems. SDC systems are distributed database systems that have been introduced to provide the increased reliability and scalability sought by customers. An SDC database system is a system that has a cluster of two or more database servers having shared access to a database on disk storage and network interconnect between them. The term “cluster” refers to the fact that these systems involve a plurality of networked server instances that are clustered together to function as a single system. Each instance in the cluster usually contains its own CPU and memory, and all instances in the cluster communicate with each other, typically through private interconnects. “Shared disk” refers to the fact that two or more database servers share access to the same disk image of the database. In a typical database server with shared disk cluster (e.g. ASE-CE), a transaction runs on a single instance in the cluster; such a cluster instance is called an owner instance of the transaction. The state of a transaction is maintained on the owner instance. All the SQL statements under the transaction are issued to the owner instance and are executed by it.

SDC database systems provide for transparent, continuous availability of the applications running on the cluster with instantaneous failover amongst servers in the cluster. When one instance is down (e.g., for upgrading the CPU) the applications are able to continue to operate against the shared data using the remaining instances in the cluster, so that a continuously available solution is provided. SDC systems also enable users to address scalability problems by simply adding additional machines to the cluster, without major data restructuring and the associated system downtime that is common in prior SMP (symmetric multiprocessor) environments.

While such continuous operation is a benefit of SDC implementation, greater operational benefits could be realized by enabling distributed transaction support in an SDC environment. More particularly, a need exists for maintaining transaction consistency for distributed transactions in SDC. The present invention addresses such a need.

### BRIEF SUMMARY

Briefly stated, the invention includes system, method, computer program product embodiments and combinations and sub-combinations thereof for maintaining transaction consistency for distributed transactions in a distributed shared disk cluster environment. An embodiment includes utilizing broadcast messaging among the plurality of instances to identify at least one of a transaction and a transaction owner instance for a transaction request. Execution of the transaction occurs on an owner instance as found based on a response to the broadcast messaging.

With the aspects of the invention, distributed transaction management in a shared disk cluster database is successfully supported by maintaining unique transaction names across instances in the cluster in a manner that needs zero disk I/Os and minimal communication between the instances. Further, though the idea for maintaining unique transaction names is developed for the sake of DTM, it can be applied to similar problems in distributed systems. In addition, the invention provides an approach to abstract from applications the multi-instance distributed architecture of a SDC using a connection migration technique. In order to comply with distributed transaction protocols, the invention also handles instance failures by re-instantiating prepared transactions running on a failed instance. Further embodiments, features, and advantages of the invention, as well as the structure and operation of the various embodiments of the invention, are described in detail below with reference to accompanying drawings.

### BRIEF DESCRIPTION OF THE DRAWINGS/FIGURES

The accompanying drawings, which are incorporated herein and form part of the specification, illustrate embodiments of the present invention and, together with the description, further serve to explain the principles of the invention and to enable a person skilled in the relevant art(s) to make and use the invention.

FIG. 1 illustrates an example usage scenario of DTM execution.

FIG. 2a illustrates a very general block diagram of a computer system (e.g., an IBM-compatible system) in which software-implemented processes of the present invention may be embodied.

FIG. 2b illustrates the general structure of a client/server database system 200 suitable for implementing the present invention.

FIG. 3 illustrates a high-level block diagram of a Shared Disk Cluster database system environment useful for implementing components of embodiments of the invention.

FIG. 4 is a block diagram illustrating components of an instance of a clustered database server implementing the shared disk cluster system and methodology of the present invention.

FIG. 5 illustrates a block flow diagram of an overall process to maintaining transaction consistency for distributed transaction management in accordance with embodiments of the present invention.

FIG. 6 illustrates a block flow diagram of utilizing broadcast messaging for reserving a transaction identifier in accordance with embodiments of the present invention.

FIG. 7 illustrates a block flow diagram for using broadcast messaging to ensure that a transaction request is performed on an owner instance in accordance with embodiments of the present invention.

FIG. 8 illustrates a block flow diagram of a process for re-instantiation of prepared DTM transactions in accordance with embodiments of the invention.

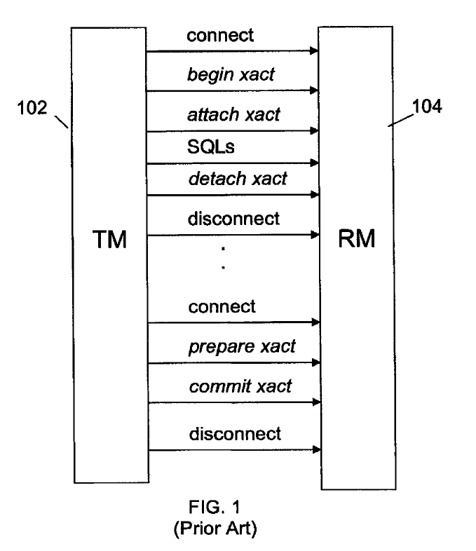

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION

The present invention relates to a system, method, computer program product embodiments and combinations and sub-combinations thereof for maintaining transaction consistency for distributed transactions in a distributed shared disk cluster environment.

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

### Glossary

The following definitions are offered for purposes of illustration, not limitation, in order to assist with understanding the discussion that follows.

Relational Database Management System (RDBMS): A system for storing and retrieving data from two-dimensional tables in which the use of SQL is standard.

Distributed Transaction: A transaction that updates data on two or more networked computer systems. Distributed transactions, as with any other transactions, must have all four ACID (atomicity, consistency, isolation, durability) properties. Messaging is done between the systems to ensure ACID properties for the transaction

Resource Manager (RM): An executable image or linked-in component that manages some parts of a computer's shared resources. Software entities outside the RM domain act as clients in accessing the managed resources. Some examples of RMs are print servers and, most notably for this discussion, an RDBMS such as ASE (Adaptive Server Enterprise). In a DTP environment, it is the RM(s) that do the actual work of data transformation or event generation.

Transaction Manager(TM): A program that manages distributed transactions. It coordinates the decisions to commit or rollback, and coordinates failure recovery between the Resource Managers. It is also known as the Transaction Monitor or Transaction Processing Monitor (TP).

Two-phase Commit Protocol: A protocol that is used to either commit or abort a distribution transaction. In the first phase, the Transaction Manager asks each resource manager if it is prepared to commit. If all participants say yes, then in the second phase the Transaction Manager broadcasts the commit message to all of the participants. If any of the participants fail during the first phase, the distribution transaction is aborted.

Distributed Transaction Processing (DTP): DTP Systems are those where work in support of a single transaction may occur across multiple Resource Managers. A DTP system has a way to refer to a transaction that encompasses all work done anywhere within its system.

Connect Instance: Instance in the cluster receiving the DTM-RPC for a transaction.

Owner Instance: Instance in the cluster running the transaction.

Connection Migration: A mechanism which allows migration of established client connection from its current instance to another instance in the cluster.

Referring to the figures, exemplary embodiments of the invention will now be described. The following description will focus on the presently preferred embodiment of the present invention, which is implemented in desktop and/or server software (e.g., driver, application, or the like) operating in an Internet-connected environment running under an operating system, such as the Microsoft Windows operating system. The present invention, however, is not limited to any one particular application or any particular environment. Instead, those skilled in the art will find that the system and methods of the present invention may be advantageously embodied on a variety of different platforms, including Macintosh, Linux, Solaris, UNIX, FreeBSD, and the like. Therefore, the description of the exemplary embodiments that follows is for purposes of illustration and not limitation. The exemplary embodiments are primarily described with reference to block diagrams or flowcharts. As to the flowcharts, each block within the flowcharts represents both a method step and an apparatus element for performing the method step. Depending upon the implementation, the corresponding apparatus element may be configured in hardware, software, firmware, or combinations thereof.

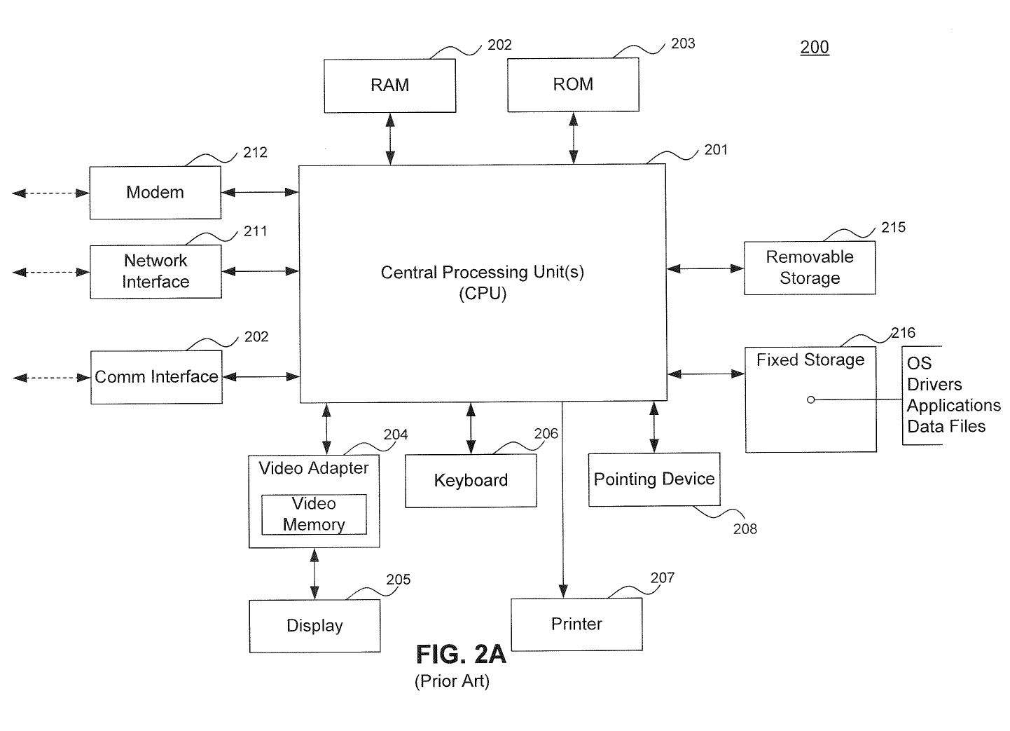

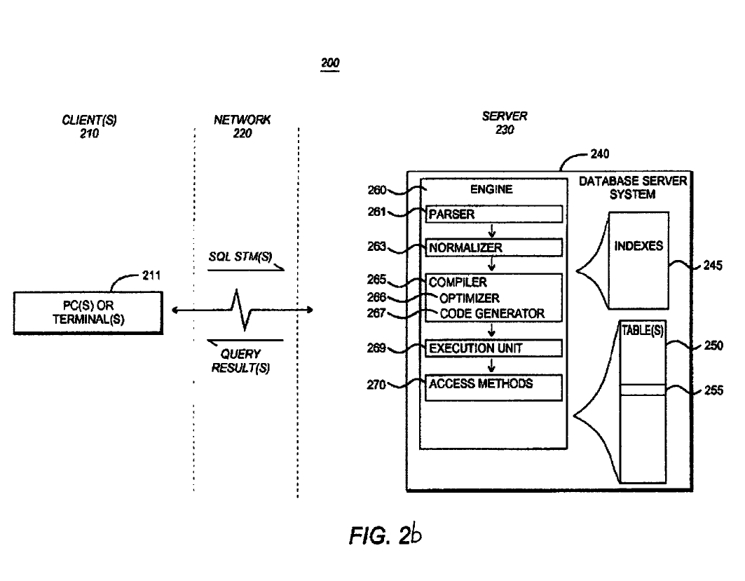

The present invention may be implemented on a conventional or general-purpose computer system, such as an IBM-compatible personal computer (PC) or server computer. FIG. 2a is a very general block diagram of a computer system (e.g., an IBM-compatible system) in which software-implemented processes of the present invention may be embodied. As shown, system 2100 comprises a central processing unit(s) (CPU) or processor(s) 2101 coupled to a random-access memory (RAM) 2102, a read-only memory (ROM) 2103, a keyboard 106, a printer 2107, a pointing device 2108, a display or video adapter 2104 connected to a display device 2105, a removable (mass) storage device 2115 (e.g., floppy disk, CD-ROM, CD-R, CD-RW, DVD, or the like), a fixed (mass) storage device 2116 (e.g., hard disk), a communication (COMM) port(s) or interface(s) 2110, a modem 2112, and a network interface card (NIC) or controller 2111 (e.g., Ethernet). Although not shown separately, a real time system clock is included with the system 2100, in a conventional manner.

CPU 2101 comprises a processor of the Intel Pentium family of microprocessors. However, any other suitable processor may be utilized for implementing the present invention. The CPU 2101 communicates with other components of the system via a bi-directional system bus (including any necessary input/output (I/O) controller circuitry and other “glue” logic). The bus, which includes address lines for addressing system memory, provides data transfer between and among the various components. Description of Pentium-class microprocessors and their instruction set, bus architecture, and control lines is available from Intel Corporation of Santa Clara, Calif. Random-access memory 2102 serves as the working memory for the CPU 2101. In a typical configuration, RAM of sixty-four megabytes or more is employed. More or less memory may be used without departing from the scope of the present invention. The read-only memory (ROM) 2103 contains the basic input/output system code (BIOS)—a set of low-level routines in the ROM that application programs and the operating systems can use to interact with the hardware, including reading characters from the keyboard, outputting characters to printers, and so forth.

Mass storage devices 2115, 2116 provide persistent storage on fixed and removable media, such as magnetic, optical or magnetic-optical storage systems, flash memory, or any other available mass storage technology. The mass storage may be shared on a network, or it may be a dedicated mass storage. As shown in FIG. 2a, fixed storage 2116 stores a body of program and data for directing operation of the computer system, including an operating system, user application programs, driver and other support files, as well as other data files of all sorts. Typically, the fixed storage 2116 serves as the main hard disk for the system.

In basic operation, program logic (including that which implements methodology of the present invention described below) is loaded from the removable storage 2115 or fixed storage 2116 into the main (RAM) memory 2102, for execution by the CPU 2101. During operation of the program logic, the system 2100 accepts user input from a keyboard 2106 and pointing device 2108, as well as speech-based input from a voice recognition system (not shown). The keyboard 2106 permits selection of application programs, entry of keyboard-based input or data, and selection and manipulation of individual data objects displayed on the screen or display device 2105. Likewise, the pointing device 2108, such as a mouse, track ball, pen device, or the like, permits selection and manipulation of objects on the display device. In this manner, these input devices support manual user input for any process running on the system.

The computer system 2100 displays text and/or graphic images and other data on the display device 2105. The video adapter 2104, which is interposed between the display 2105 and the system's bus, drives the display device 2105. The video adapter 2104, which includes video memory accessible to the CPU 2101, provides circuitry that converts pixel data stored in the video memory to a raster signal suitable for use by a cathode ray tube (CRT) raster or liquid crystal display (LCD) monitor. A hard copy of the displayed information, or other information within the system 2100, may be obtained from the printer 2107, or other output device.

The system itself communicates with other devices (e.g., other computers) via the network interface card (NIC) 2111 connected to a network (e.g., Ethernet network, Bluetooth wireless network, or the like), and/or modem 2112 (e.g., 56 K baud, ISDN, DSL, or cable modem). The system 2100 may also communicate with local occasionally-connected devices (e.g., serial cable-linked devices) via the communication (COMM) interface 2110, which may include a RS-232 serial port, a Universal Serial Bus (USB) interface, or the like. Devices that will be commonly connected locally to the interface 2110 include laptop computers, handheld organizers, digital cameras, and the like.

IBM-compatible personal computers and server computers are available from a variety of vendors. Representative vendors include Dell Computers of Round Rock, Tex., Hewlett-Packard of Palo Alto, Calif., and IBM of Armonk, N.Y. Other suitable computers include Apple-compatible computers (e.g., Macintosh), which are available from Apple Computer of Cupertino, Calif., and Sun Solaris workstations, which are available from Sun Microsystems of Mountain View, Calif.

A software system is typically provided for controlling the operation of the computer system 2100. The software system, which is usually stored in system memory (RAM) 2102 and on fixed storage (e.g., hard disk) 2116, includes a kernel or operating system (OS) which manages low-level aspects of computer operation, including managing execution of processes, memory allocation, file input and output (I/O), and device I/O. The OS can be provided by a conventional operating system, e.g., Microsoft Windows NT, Microsoft Windows 2000, Microsoft Windows XP, or Microsoft Windows Vista (Microsoft Corporation of Redmond, Wash.) or an alternative operating system, such as the previously mentioned operating systems. Typically, the OS operates in conjunction with device drivers (e.g., “Winsock” driver—Windows' implementation of a TCP/IP stack) and the system BIOS microcode (i.e., ROM-based microcode), particularly when interfacing with peripheral devices. One or more application(s), such as client application software or “programs” (i.e., set of processor-executable instructions), may also be provided for execution by the computer system 2100. The, application(s) or other software intended for use on the computer system may be “loaded” into memory 2102 from fixed storage 2116 or may be downloaded from an Internet location (e.g., Web server). A graphical user interface (GUI) is generally provided for receiving user commands and data in a graphical (e.g., “point-and-click”) fashion. These inputs, in turn, may be acted upon by the computer system in accordance with instructions from OS and/or application(s). The graphical user interface also serves to display the results of operation from the OS and application(s).

The above-described computer hardware and software are presented for purposes of illustrating the basic underlying desktop and server computer components that may be employed for implementing the present invention. For purposes of discussion, the following description will present examples in which it will be assumed that there exists a “server” (e.g., Web server) that communicates with one or more “clients” (e.g., desktop computers). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

While the present invention may operate within a single (standalone) computer (e.g., system 2100 of FIG. 2a), the present invention is preferably embodied in a multi-user computer system, such as a client/server system. FIG. 2b illustrates the general structure of a client/server database system 200 suitable for implementing the present invention. As shown, the system 200 comprises one or more client(s) 210 connected to a server 230 via a network 220. Specifically, the client(s) 210 comprise one or more standalone terminals 211 connected to a database server system 240 using a conventional network. In an exemplary embodiment, the terminals 211 may themselves comprise a plurality of standalone workstations, dumb terminals, or the like, or comprise personal computers (PCs) such as the above-described system 2100. Typically, such units would operate under a client operating system, such as a Microsoft™ Windows client operating system (e.g., Microsoft™ Windows 95/98, Windows 2000, Windows XP, Windows Vista).

The database server system 240, which comprises Sybase™ Adaptive Server™ Enterprise (available from Sybase, Inc. of Dublin, Calif.) in an exemplary embodiment, generally operates as an independent process (i.e., independently of the clients), running under a server operating system such as Microsoft™ Windows NT, Windows 2000, or Windows XP (all from Microsoft Corporation of Redmond, Wash.), UNIX (Novell), Solaris (Sun), or Linux (Red Hat). The network 220 may be any one of a number of conventional network systems, including a Local Area Network (LAN) or Wide Area Network (WAN), as is known in the art (e.g., using Ethernet, IBM Token Ring, or the like). The network 220 includes functionality for packaging client calls in the well-known Structured Query Language (SQL) together with any parameter information into a format (of one or more packets) suitable for transmission to the database server system 240.

Client/server environments, database servers, and networks are well documented in the technical, trade, and patent literature. For a discussion of Sybase™-branded database servers and client/server environments generally, see, e.g., Nath, A., “The Guide to SQL Server”, Second Edition, Addison-Wesley Publishing Company, 1995. For a description of Sybase™ Adaptive Server™ Enterprise, see, e.g., “Adaptive Server Enterprise 15.0 Collection: (1) Core Documentation Set and (2) Installation and Configuration,” available from Sybase, Inc. of Dublin, Calif. This product documentation is available via the Internet (e.g., currently at sybooks.sybase.com). The disclosures of the foregoing are hereby incorporated by reference.

In operation, the client(s) 210 store data in, or retrieve data from, one or more database tables 250, as shown at FIG. 2b. Data in a relational database is stored as a series of tables, also called relations. Typically resident on the server 230, each table itself comprises one or more “rows” or “records” (tuples) (e.g., row 255 as shown at FIG. 2b). A typical database will contain many tables, each of which stores information about a particular type of entity. A table in a typical relational database may contain anywhere from a few rows to millions of rows. A row is divided into fields or columns; each field represents one particular attribute of the given row. A row corresponding to an employee record, for example, may include information about the employee's ID Number, Last Name and First Initial, Position, Date Hired, Social Security Number, and Salary. Each of these categories, in turn, represents a database field. In the foregoing employee table, for example, Position is one field, Date Hired is another, and so on. With this format, tables are easy for users to understand and use. Moreover, the flexibility of tables permits a user to define relationships between various items of data, as needed. Thus, a typical record includes several categories of information about an individual person, place, or thing. Each row in a table is uniquely identified by a record ID (RID), which can be used as a pointer to a given row.

Most relational databases implement a variant of the Structured Query

Language (SQL), which is a language allowing users and administrators to create, manipulate, and access data stored in the database. The syntax of SQL is well documented; see, e.g., the above-mentioned “An Introduction to Database Systems”. SQL statements may be divided into two categories: data manipulation language (DML), used to read and write data; and data definition language (DDL), used to describe data and maintain the database. DML statements are also called queries. In operation, for example, the clients 210 issue one or more SQL commands to the server 230. SQL commands may specify, for instance, a query for retrieving particular data (i.e., data records meeting the query condition) from the database table(s) 250. In addition to retrieving the data from database server table(s) 250, the clients 210 also have the ability to issue commands to insert new rows of data records into the table(s), or to update and/or delete existing records in the table(s).

SQL statements or simply “queries” must be parsed to determine an access plan (also known as “execution plan” or “query plan”) to satisfy a given query. In operation, the SQL statements received from the client(s) 210 (via network 220) are processed by the engine 260 of the database server system 240. The engine 260 itself comprises a parser 261, a normalizer 263, a compiler 265, an execution unit 269, and access methods 270. Specifically, the SQL statements are passed to the parser 261 which converts the statements into a query tree—a binary tree data structure which represents the components of the query in a format selected for the convenience of the system. In this regard, the parser 261 employs conventional parsing methodology (e.g., recursive descent parsing).

The query tree is normalized by the normalizer 263. Normalization includes, for example, the elimination of redundant data. Additionally, the normalizer 263 performs error checking, such as confirming that table names and column names which appear in the query are valid (e.g., are available and belong together). Finally, the normalizer 263 can also look-up any referential integrity constraints which exist and add those to the query.

After normalization, the query tree is passed to the compiler 265, which includes an optimizer 266 and a code generator 267. The optimizer 266 is responsible for optimizing the query tree. The optimizer 266 performs a cost-based analysis for formulating a query execution plan. The optimizer will, for instance, select the join order of tables (e.g., when working with more than one table), and will select relevant indexes (e.g., when indexes are available). The optimizer, therefore, performs an analysis of the query and selects the best execution plan, which in turn results in particular access methods being invoked during query execution. It is possible that a given query may be answered by tens of thousands of access plans with widely varying cost characteristics. Therefore, the optimizer must efficiently select an access plan that is reasonably close to an optimal plan. The code generator 267 translates the query execution plan selected by the query optimizer 266 into executable form for execution by the execution unit 269 using the access methods 270.

All data in a typical relational database system is stored in pages on a secondary storage device, usually a hard disk. Typically, these pages may range in size from 1 Kb (kilobyte) to 32 Kb, with the most common page sizes being 2 Kb and 4 Kb. For purposes of the description that follows, it will be assumed that the database page size is 2 Kb, although it can be one of 2 Kb, 4 Kb, 8 Kb and 16 Kb. All input/output operations (I/O) against secondary storage are done in page-sized units—that is, the entire page is read/written at once. Pages are also allocated for one purpose at a time: a database page may be used to store table data or used for virtual memory, but it will not be used for both. The memory in which pages that have been read from disk reside is called the cache or buffer pool.

I/O to and from the disk tends to be the most costly operation in executing a query. This is due to the latency associated with the physical media, in comparison with the relatively low latency of main memory (e.g., RAM). Query performance can thus be increased by reducing the number of I/O operations that must be completed. This can be done by using data structures and algorithms that maximize the use of pages that are known to reside in the cache. Alternatively, it can be done by being more selective about what pages are loaded into the cache in the first place. An additional consideration with respect to I/O is whether it is sequential or random. Due to the construction of hard disks, sequential I/O is much faster then random access I/O. Data structures and algorithms encouraging the use of sequential I/O can realize greater performance.

For enhancing the storage, retrieval, and processing of data records, the server 230 maintains one or more database indexes 245 on the database tables 250. Indexes 245 can be created on columns or groups of columns in a table. Such an index allows the page containing rows that match a certain condition imposed on the index columns to be quickly located on disk, rather than requiring the engine to scan all pages in a table to find rows that fulfill some property, thus facilitating quick access to the data records of interest. Indexes are especially useful when satisfying equality and range predicates in queries (e.g., a column is greater than or equal to a value) and “order by” clauses (e.g., show all results in alphabetical order by a given column).

The above-described computer hardware and software are presented for purposes of illustrating the basic underlying computer components (e.g., database server) that may be employed for implementing the present invention. For purposes of discussion, the following description will present examples in which it will be assumed that there exists a “server” (e.g., database server) for purposes of implementing the processes described below. In typical operation, such a server communicates with one or more other computers, including “clients” (e.g., customer or end-user computers that are “database clients” of the server). The present invention, however, is not limited to any particular environment or device configuration. In particular, a client/server distinction is not necessary to the invention, but is used to provide a framework for discussion. Instead, the present invention may be implemented in any type of system architecture or processing environment capable of supporting the methodologies of the present invention presented in detail below.

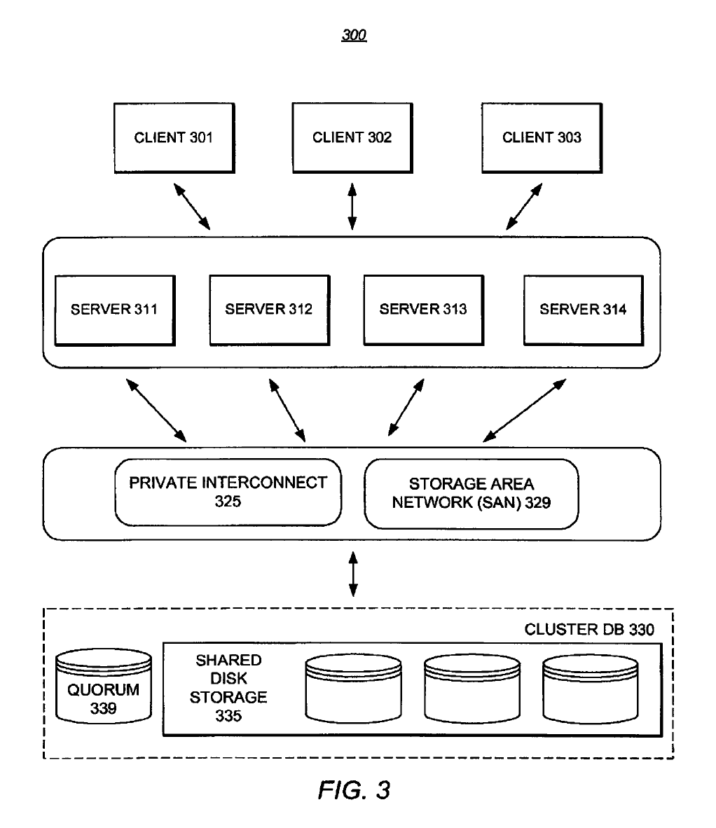

As previously mentioned, one type of architecture of a distributed database system is a shared disk cluster (SDC) architecture. In this architecture, multiple computer systems, each with a private memory share a common collection of disks. Each computer system in a SDC is also referred to as a instance. FIG. 3 is a high-level block diagram of a Shared Disk Cluster database system environment 300 illustrating an example of a four instance (servers 311, 312, 313, 314) Shared Disk Cluster accessed by a plurality of clients (clients 301, 302, 303). The term “cluster” refers to a collection of more than one networked (and usually homogeneous) instances, which function as a single system. Each instance generally contains its own CPU and memory resources. The term “clustered server” refers to a database server (currently implemented using Sybase™ Adaptive Server™ Enterprise (“ASE”) available from assignee Sybase of Dublin, Calif.) which runs on a cluster (cluster DB 330) and jointly manages a single installation of the databases on the shared disk storage 335. As shown, the environment 300 also includes a quorum disk 339. The quorum disk 339 is a shared disk device used for cluster membership arbitration. The quorum disk also maintains a history of runtime cluster view changes.

A Shared Disk Cluster database system can be implemented using low cost “blade servers” such as Intel/Linux machines. In the presently preferred embodiment, instances in the cluster communicate with each other through private interconnects (e.g., private interconnect 325). As shown at FIG. 3, the instances are interconnected via redundant high-speed interconnects with each instance also having a direct connection to all databases on a disk subsystem. Gigabit Ethernet and Infiniband may be used to provide these high-speed interconnects. The storage subsystem may be implemented using raw device support with a storage area network (SAN 329) or with file system support (e.g., through use of a clustered file system such as those from Veritas or Polyserv).

The above-described computer hardware and software are presented for purposes of illustrating the basic underlying desktop and server computer components that may be employed for implementing the present invention. For purposes of discussion, the following description will present examples in which it will be assumed that there exist multiple server instances (e.g., database servers) in a Shared Disk Cluster environment that communicate with one or more “clients” (e.g., personal computers or mobile devices). The present invention, however, is not limited to any particular environment or device configuration. Instead, the present invention may be implemented in any type of system architecture or processing environment capable of supporting the methodologies of the present invention presented in detail below.

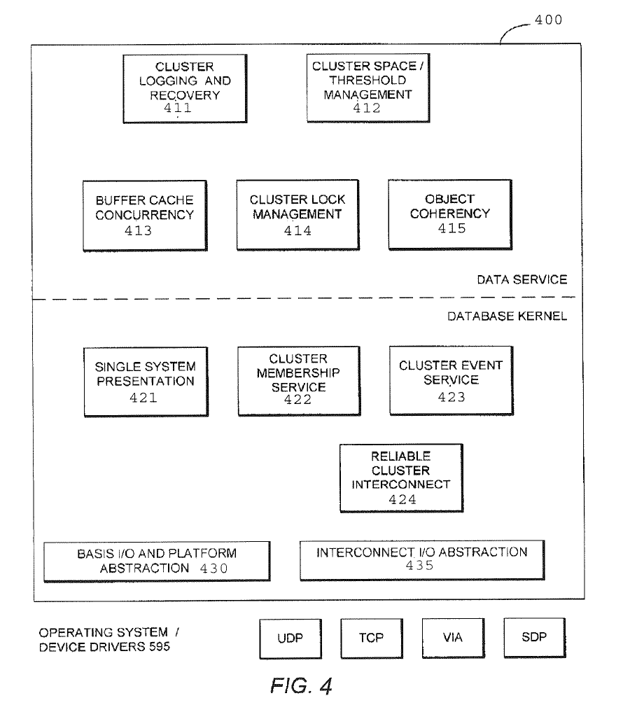

FIG. 4 is a block diagram illustrating components of an instance of a clustered database server 400 implementing the shared disk cluster system and methodology of the present invention. As shown, components of an instance of a clustered database server 400 includes data service level components and database server kernel level components. For simplicity, other conventional modules of the database system are not shown at FIG. 4. Also, the diagram shown at FIG. 4 does not attempt to illustrate the inter-dependencies among the cluster-aware components in a data server and in the kernel.

The components provided at the database kernel level include a single system presentation 421, a cluster membership service module 422, a cluster event service 423, and a reliable cluster interconnect module 424. These components are native cluster infrastructure components that enable the clustered database servers to run in a shared disk cluster environment. The cluster membership service module 422 maintains cluster membership and detects member failure. A responsibility of cluster membership service 422 is to detect cluster membership changes and maintain a reliable and consistent run time cluster view to all clustered servers. The cluster interconnect module 424 provides messaging services and an interconnect abstraction layer to allow clustered servers to communicate with each other via redundant interconnects. The cluster event service 423 supports a generic event publishing and subscription mechanism for cluster-wide events. The single system presentation module 421 supports single database presentation to clients and redirects client connections based on workload of the clustered servers and/or other criteria, such as application partitioning.

The database kernel level components also include a basis I/O and platform abstraction module 430 and an interconnect I/O abstraction module 435. An I/O abstraction layer is provided on top of the cluster platform specific private interconnects. It also supports redundant cluster interconnects (if available) with automatic fail-overs in the event of a link failure. The redundant cluster interconnects can be used to achieve both load balancing and high availability. As also shown at FIG. 4, several protocols are also supported under the I/O abstraction layer, including UDP (datagram socket), TCP (stream socket), VIA (Virtual Interface Architecture) and SDP (Socket Direct Protocol for Infiniband).

At the database data service level, components include a cluster logging and recovery module 411, a cluster space/threshold management module 412, a buffer cache coherency module (“BCM”) 413, a cluster lock management module 414, and an object coherency module (“OCM”) 415. The cluster logging and recovery module 411 deals with the issue of single logging from all clustered servers and fail-over database recovery. The cluster space and threshold management module 412 handles space utilization and implements threshold management methodology. The buffer cache coherency module 413 deals with the coherency issues related to shared buffer cache and cache to cache page transfer for allocation pages, index pages, data pages and OAM/GAM pages. The object coherency module 415 deals with the coherency issues related to sharing and transferring metadata and global variables in the shared disk cluster environment. The cluster lock management module 414 (or cluster lock manager which is sometimes referred to herein as the “CLM”) supports distributed locking for coherency control across the shared disk cluster.

In some systems, such as ASE, a particular transaction can run only on a single instance in the cluster, and the state of the transaction is maintained only on the same instance. This introduces different issues in providing distributed transaction support on SDC. For example, distributed transaction protocol demands that the RM should maintain the uniqueness of transaction names of the transactions running on it. An SDC acts as a single RM so uniqueness of transaction names should be maintained across instances in the cluster. To achieve this, an efficient mechanism to determine duplicate transaction names in the cluster is needed, moreover race conditions between multiple concurrent requests to begin the transaction need to be handled correctly.

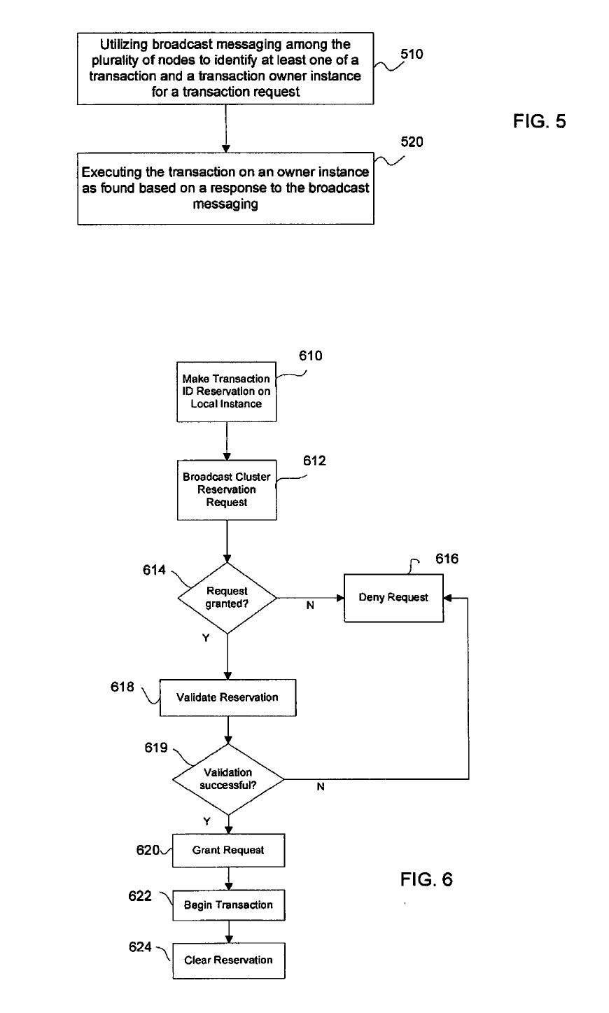

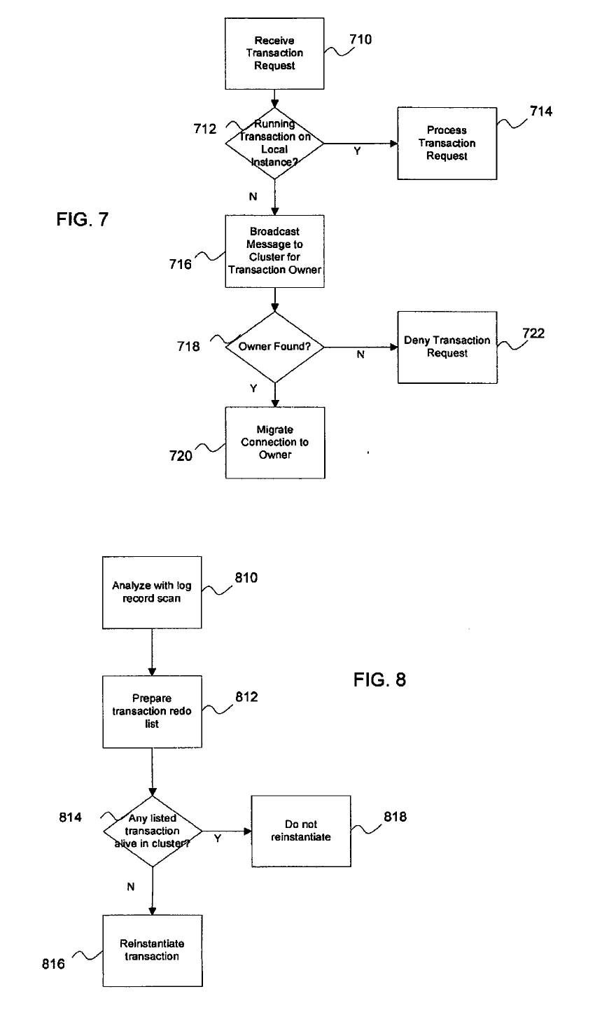

Referring now to FIG. 5, a block flow diagram illustrates an overall approach to maintaining transaction consistency for distributed transactions in accordance with embodiments of the present invention. As shown, the approach includes utilizing broadcast messaging among the plurality of instances to identify at least one of a transaction and a transaction owner instance for a transaction request (block 510). Execution of the transaction occurs on an owner instance as found based on a response to the broadcast messaging (block 520). Details of the overall approach are presented hereafter with reference to FIG. 6 and FIG. 7.

Referring now to FIG. 6, a block flow diagram is presented for utilizing broadcast messaging for reserving a transaction identifier in accordance with embodiments of the present invention. In general, before beginning a transaction, an instance first reserves the right to begin the transaction with a given transaction name by sending a reservation request to all other cluster instances in the cluster. An instance proceeds to begin the transaction only if the reservation succeeds on all the instances.

Thus, to reserve the rights to begin the transaction with a particular transaction identifier, a reservation for the transaction identifier is made on the local instance (block 610), e.g., in a local reservation table. To make the local reservation, spinlock protection is used to avoid collisions between multiple reservation requests on the same instance, as is well appreciated in the art. Further, the local reservation is made once the instance determines that it is not running a transaction with the given transaction identifier and that no other process on the instance has already made a reservation for the transaction identifier by checking the other entries in the local reservation table.

After making the local reservation, a reservation request is broadcast to all the other instances in the cluster (block 612) to determine whether the request can be granted (block 614). Each instance grants the reservation if certain conditions are met. Included in these conditions are that the instance is not running a transaction with the given transaction identifier and that the reservation for the transaction identifier is not granted to a process on the instance. Alternatively, if a reservation for the transaction identifier is granted to a process on the instance but the instance identifier of the requesting instance is smaller than that of determining instance, the request will be granted. The granting causes that instance to invalidate its reservation, if any, and grant the reservation to the requesting instance. This approach is needed to make sure that parallel requests on two different instances do not cancel out each other. In this scheme, the instance with a smaller instance id will get the priority and will start the transaction.

When the conditions are not met, the request is denied (block 616), e.g., with signaling of an error code. Otherwise, the process validates its reservation (block 618) to make sure that it is not yet invalidated by some concurrent request from an instance with a smaller instance id. If the validation is not successful (as determined via block 619), the request is denied (block 616). If the validation is successful, the request is granted (block 620). The instance begins the transaction (block 622), and then clears the reservation (block 624). These acts preferably occur using the same spinlock, so that all reservations are synchronized, as is well appreciated by those skilled in the art.

In addition to supporting distributed transaction management in an SDC by ensuring a unique transaction identifier for a transaction request, embodiments of the present invention also use broadcast messaging to ensure that a transaction request is executed on an owner instance, as described with reference to the block flow diagram of FIG. 7. In general, the instance running the transaction is found, and the request is transferred to the correct instance using a connection migration mechanism as needed.

Referring now to FIG. 7, the process initiates when a request for a transaction arrives at an instance (block 710). If the instance is running the transaction (block 712 is affirmative), the request is processed (block 714) on the same instance. If the instance is not running the transaction (block 712 is negative), then it sends a broadcast message to discover if some other instance in the cluster is running the transaction (block 716) with the given transaction name. The instance which received the original request is referred to as connect instance, and the instance running the transaction is referred to as owner instance. To find out the owner instance, the connect instance sends a broadcast request in the cluster asking if some other instance is running the transaction and then waits for reply. If one of the other instances is running the transaction (block 718 is affirmative), then that instance will respond back with a “success” message. Then connect instance migrates the connection to the owner instance (block 720). After successful migration, the request is served on the owner instance. The connection migration is transparent to the applications and is carried out by the database connectivity library and database server. The client need not reissue the request after connection migration, but the server internally determines the request made and processes it. If the transaction is not found on any of the cluster instances, then the request is denied (block 722), e.g. through an error code indication.

By way of example, suppose a TM connects to an instance, instance-1, and requests to begin a transaction with transaction id as t_1_{—}1:1. A process on instance-1 processing the request reserves the transaction identifier in its local reservation table and seeks the reservation on remote instances, instance-2 and instance-3. After a successful reservation, it will begin the transaction. The TM then attaches to the transaction to do the updates/selects, detaches from the transaction, and then disconnects. After a while, the TM again connects to the cluster, but this time to instance-2 and requests to attach to the transaction. Instance-2 determines that the transaction is running on instance-1 and then migrates the connection to instance-1. After connection migration succeeds, the attach request gets processed on instance-1. Note that the connection migration and the execution of request are transparent to the TM through handling by the appropriate connectivity libraries on the TM side and the database server.

After the attach succeeds, the TM continues its transactional work and then detaches, prepares the transaction and then completes (commits/rollbacks) the transaction. Of course, if the prepare, commit or rollback requests arrive on some other instance than instance_1, then they will get migrated and processed on instance_1 using the connection migration technique.

Further, it is recognized that a cluster instance might crash at any moment. As there might be prepared transactions running on the crashed instance, the process of bringing a prepared transaction to the state in which it was at the time of the crash, so that it can be committed or aborted as instructed by the TM on a different instance, is referred to as “re-instantiation”. Note that, following distributed transaction protocol, an RM can not commit/rollback a prepared transaction; it has to make sure that it commit/aborts the transaction as indicated by TM. Re-instantiation of a prepared transaction insures that an RM can follow the next commit/rollback command from the TM. In instance failover recovery terminology, the instance which crashed is called the failed-instance, and the instance which recovers the transactions of the failed-instance is called the recovering-instance. Generally, recovery includes a first phase, “analysis”, during which a forward scan is done of the log from the beginning of the oldest open transaction at the time of the most recent checkpoint and a table of information is built about transactions and the work that needs to be done. A second phase, “redo”, scans the log forward and ensures that all the modifications in the log have been applied to pages in the databases. A third phase, “undo”, scans the log backward and rolls back the work done by each modification belonging to an incomplete transaction, generating rollback log records to account for this work.

Further, the normal procedure followed by the cluster instance failover recovery process to handle the case where the transaction is newly started on the failed instance is to read only the log records written by the failed instance. However, when the transaction is a re-instantiated transaction on the failed instance, the log records written by all the instances need to be read. By way of example, consider the following sequence. Suppose a transaction, T1, reached prepared state on an instance, I1, and I1 crashes. Instance 12 recovers I1 and re-instantiates T1. I2 crashes. Instance 13 recovers 12. T1 has to be re-instantiated. The log records written for the transaction T1 will be tagged with instance id I1. When I3 recovers I2, if the log records written by I1 are not read, the failover process will not realize that T1 ever existed and hence will not be re-instantiated. This would not serve one of the basic functionalities of DTM and is unacceptable.

Thus, in accordance with embodiments of the invention, the log records of all the instances are read during recovery, since there is no advance knowledge of which instance might have originally started the transaction. To avoid multiple instantiations of the transaction, the re-instantiation process determines whether the transaction is already alive on any instance in the cluster, and if it is alive on any instance in the cluster, the transaction is not re-instantiated.

FIG. 8 illustrates a block flow diagram of a process for re-instantiation of prepared DTM transactions in accordance with embodiments of the invention. During the analysis phase, a scan of the log records occurs (block 810), and a list is made including prepared DTM transactions that are not committed or rolled back (block 812).

In the redo phase, a check is made to see if the same transaction is alive on any other instance in the cluster (block 814). If it is not alive on any instance, it is re-instantiated (block 816) using standard techniques. If it is alive, it does not need to be re-instantiated (block 818).

As described herein, with the aspects of the invention, distributed transaction management in shared disk cluster database is successfully supported with maintenance of unique transaction names across instances in a manner that needs zero disk I/Os and minimum communication between the instances. Further, though the idea for maintaining unique transaction names is developed for the sake of DTM, it can be applied to similar problems in distributed systems. In addition, the invention provides an approach to abstract from applications the multi-instance distributed architecture of a SDC using a connection migration technique. Further, in order to comply with distributed transaction protocols, handling instance failures successfully occurs by re-instantiating prepared transactions running on a failed instance.

The invention can work with software, hardware, and/or operating system implementations other than those described herein. Any software, hardware, and operating system implementations suitable for performing the functions described herein can be used.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. In a distributed shared disk cluster environment comprising a plurality of instances, a method for maintaining transaction consistency for distributed transactions, the method comprising:
utilizing broadcast messaging among the plurality of instances to identify at least one of a transaction and a transaction owner instance for a transaction request; and
executing the transaction on an owner instance as found based on a response to the broadcast messaging.

2. The method of claim 1 wherein identifying a transaction further comprises identifying availability of a transaction name.

3. The method of claim 2 further comprises reserving the transaction name as a unique name locally and remotely without accessing disk storage.

4. The method of claim 3 wherein executing the transaction further comprises executing the transaction with the reserved transaction name.

5. The method of claim 1 further comprising migration of a connection to an owner instance when a transaction request is received by a non-owner instance.

6. The method of claim 1 further comprising re-instantiating a prepared transaction when a crash occurs.

7. The method of claim 6 further comprising reading all log records of all instances in the cluster and re-instantiating prepared transactions when the transaction is not alive on any instance in the cluster.

8. A distributed shared disk cluster database system comprising:
a plurality of instances networked in the cluster, each instance utilizing broadcast messaging among the plurality of instances to identify at least one of a transaction and a transaction owner instance for a transaction request and executing the transaction on an owner instance as found based on a response to the broadcast messaging; and
disk storage shared among the cluster and having at least one database for the processing of the transaction request.

9. The system of claim 8 wherein each instance utilizing broadcast messaging further identifies a transaction by identifying availability of a transaction name.

10. The system of claim 9 wherein each instance utilizing broadcast messaging further reserves the transaction name as a unique name locally and remotely without accessing the disk storage.

11. The system of claim 10 wherein each instance executing the transaction further executes the transaction with the reserved transaction name.

12. The system of claim 8 wherein each instance that is a non-owner instance of a transaction request migrates connection to an owner instance when the transaction request is received.

13. The system of claim 8 wherein an instance re-instantiates a prepared transaction when a crash occurs.

14. The system of claim 13 wherein the instance further reads all log records of all instances in the cluster and re-instantiates prepared transactions when the transaction is not alive on any instance in the cluster.

15. A computer program product comprising a computer usable medium having computer program logic recorded thereon for enabling a processor to perform a method for maintaining transaction consistency for distributed transactions, the method comprising:
utilizing broadcast messaging among the plurality of instances to identify at least one of a transaction and a transaction owner instance for a transaction request; and
executing the transaction on an owner instance based on a response to the broadcast messaging.

16. The product of claim 15 wherein identifying a transaction further comprises identifying availability of a transaction name.

17. The product of claim 16 further comprises reserving the transaction name as a unique name locally and remotely without accessing disk storage.

18. The product of claim 17 wherein executing the transaction further comprises executing the transaction with the reserved transaction name.

19. The product of claim 15 further comprising migration of a connection to an owner instance when a transaction request is received by a non-owner instance.

20. The product of claim 15 further comprising re-instantiating a prepared transaction when a crash occurs, including reading all log records of all instances in the cluster and re-instantiating prepared transactions when the transaction is not alive on any instance in the cluster.
